(19) United States
(12) Patent Application Publication
(10) Pub. No.: US 2012/0210148 A1
(43) Pub. Date: Aug. 16, 2012

(54) ENERGY-SAVING APPARATUS USING COMPUTER USER INFORMATION, AND ENERGY-SAVING METHOD USING SAME

(76) Inventor: Hae-Yong Choi, Incheon (KR)

(21) Appl. No.: 13/502,804

(22) PCT Filed: Oct. 12, 2010
(86) PCT No.: PCT/KR10/06976

§ 371 Date: Apr. 19, 2012

(30) Foreign Application Priority Data
Oct. 19, 2009 (KR) 10-2009-0100015

(51) Int. Cl. G06F 1/32; H04W 52/02

(52) U.S. Cl. 713/310

(57) ABSTRACT

Provided are an energy-saving apparatus using computer user information and an energy-saving method using same. In detail, in order to minimize power consumption of a computer by automatically switching a power mode of the computer to an energy-saving mode according to whether the computer recognizes the computer user information, the energy-saving apparatus includes: a signal generation unit which stores and transmits the computer user information; an information transceiving unit which receives the computer user information from the signal generation unit; a storage space for storing user authentication information; a comparison unit which compares the computer user information received from the signal generation unit with the user authentication information stored in the storage space to determine whether or not the computer user information and the user authentication information match each other; and a mode switching unit which switches the power mode of the computer into the energy-saving mode according to a result of the determination of the comparison unit.

### TECHNICAL FIELD

The present invention relates to an energy-saving apparatus using computer user information and to an energy-saving method using the same. In detail, a computer is enabled to automatically enter an energy-saving mode according to whether the computer recognizes the user information so that power consumption of the computer is minimized.

### BACKGROUND ART

A computer is an indispensable item in a modern society.

As computers are widely used, computers are often kept turned on so as to be used at any time in a home or company.

Therefore, power consumption due to the use of computers is one of problems to be solved for reducing cost for a home or company. Further, to protect the environment, it is necessary to save energy.

It may be one of methods for reducing the power consumption of computers to improve energy efficiency of the computers. However, it is more important to save power when the computers are not used.

Therefore, it is necessary to develop a technology for automatically controlling power of a computer even when a user does not intentionally control the power of the computer to reduce the power consumption.

### DISCLOSURE

### Technical Problem

The present invention provides a computer energy-saving apparatus which is capable of automatically control an energy-saving mode of a computer by using computer user information, wherein the computer user information is stored in and transmitted from a signal generation unit even when a user does not recognize, and the computer user information is received through an information transceiving unit connected to the computer through wireless communication.

### Technical Solution

According to an aspect of the present invention, an energy-saving apparatus using computer user information includes: a signal generation unit configured to store and transmit computer user information; an information transceiving unit configured to receive the computer user information from the signal generation unit; a storage space configured to store user authentication information; a comparison unit configured to compare the computer user information received from the information transceiving unit with the user authentication information stored in the storage space, and determine whether there is a correlation between the computer user information and the user authentication information; and a mode switching unit configured to switch a power mode of the computer to an energy-saving mode according to a result of the determination of the comparison unit.

Herein, at least one piece of the computer user information and user authentication information may be respectively stored into the signal generation unit and storage space, and may be amended and deleted according to the need. Also, the signal generation unit may receive the computer user information stored in an IC chip or RFID tag which is an information storage unit of an IC card or RFID card through contact communication or RF communication, and may store the received information according to the need.

For the communication between the signal generation unit and the information transceiving unit, an RF communication, Bluetooth communication, or ZigBee communication technology may be used. The information transceiving unit may be integrated with a computer or may be separable from the computer. The information transceiving unit may be linked to the computer using USB or serial communication.

The energy-saving mode may include at least one of a monitor turning off mode, a monitor power-saving mode, a computer turning off mode, a system standby mode, and a hard disk turning off mode.

### Advantageous Effects

According to the energy-saving apparatus using computer user information and the energy-saving method using the same, the computer user information is continuously recognized so as to automatically switch a power mode of a computer to an energy-saving mode when it is determined that the computer is not needed to be used, thereby minimizing power consumption of the computer.

Further, according to the energy-saving apparatus using computer user information and the energy-saving method using the same, the energy-saving mode is finished by using user authentication information stored in storage space only when an authorized computer user approaches the computer. Therefore, unnecessary power consumption due to an approach of an unauthorized user can be prevented.

Further, according to the energy-saving apparatus using computer user information and the energy-saving method using the same, at least one piece of the computer user information and user authentication information can be respectively stored in the signal generation unit and storage space, and can be freely amended or deleted according to the need. Therefore, convenience of a user can be improved.

### DESCRIPTION OF DRAWINGS

The above and other features and advantages of the present invention will become more apparent by describing in detail exemplary embodiments thereof with reference to the attached drawings in which:

FIG. 1 is a diagram illustrating a first example of an energy-saving apparatus using computer user information, according to the present invention;

FIG. 2 is a diagram illustrating the first example of the energy-saving apparatus using the computer user information, according to the present invention;

FIG. 3 is a diagram illustrating a first example of an energy-saving method using computer user information, according to the present invention;

FIG. 4 is a diagram illustrating a second example of the energy-saving apparatus using the computer user information, according to the present invention;

FIG. 5 is a diagram illustrating the second example of the energy-saving apparatus using the computer user information, according to the present invention; and

FIG. 6 is a diagram illustrating a second example of the energy-saving method using the computer user information, according to the present invention.

### BEST MODE FOR CARRYING OUT THE INVENTION

Hereinafter, preferred embodiments will be described in more detail with reference to the accompanying drawings. Moreover, detailed descriptions of well-known functions or configurations will be omitted in order not to unnecessarily obscure the focus of the present invention.

When it is needed to recognize a wide range of computer user information, a long-range wireless communication technology may be used, and, when it is needed to recognize a short range of the computer user information, a short-range wireless communication technology may be used.

When a signal generation unit is located out of a recognition range of an information transceiving unit connected to a computer, the computer user information transmitted from the signal generation unit cannot be received by the information transceiving unit. In this case, since the computer cannot recognize a computer user, the computer switches to an energy-saving mode. In the absence of the computer user, for fast switching to the energy-saving mode, a wireless communication technology of which a recognition rage is about 1 m to 2 m may be used. Except when the computer user having the signal generation unit sits at a desk, i.e., when the computer user is away from the desk, the recognition of the computer user information is impossible, and thus, the computer rapidly switches to the energy-saving mode. To widen the range of recognition and cover an office, a wireless communication technology providing a wide recognition range may be used. An RF communication, ZigBee, or Bluetooth technology may be used for the wireless communication technology. In the case of the Bluetooth technology, Bluetooth class 1 provides a recognition range of about 100 m, and Bluetooth class 2 provides a recognition range of about 10 m. A suitable Bluetooth class is selected according to the need. Herein, a Bluetooth device may be used as the signal generation unit, and a Bluetooth dongle may be used as the information transceiving unit connected to the computer.

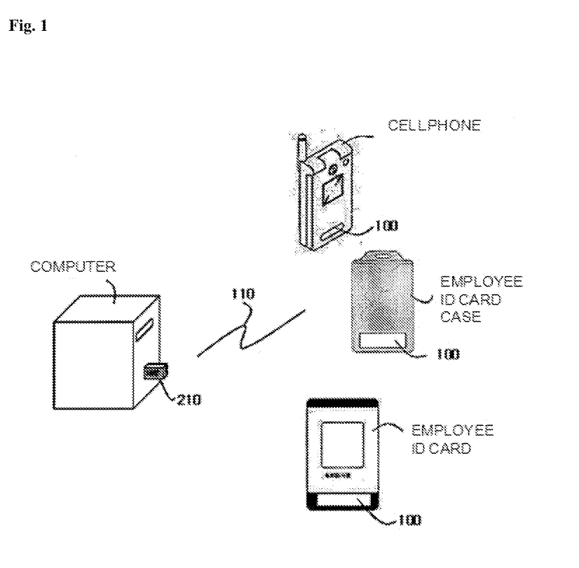

FIG. 1 is a diagram illustrating a first example of an energy-saving apparatus using computer user information, according to the present invention.

A signal generation unit 100 may be connected to a personal item such as an employee ID card, employee ID card case, or cell phone. The information transceiving unit 210 is connected to a computer and receives the computer user information transmitted from the signal generation unit through wireless communication 110. The signal generation unit 100 may continuously transmit the computer user information. Or, the signal generation unit 100 may transmit the computer user information only when the information transceiving unit 210 requests for the computer user information.

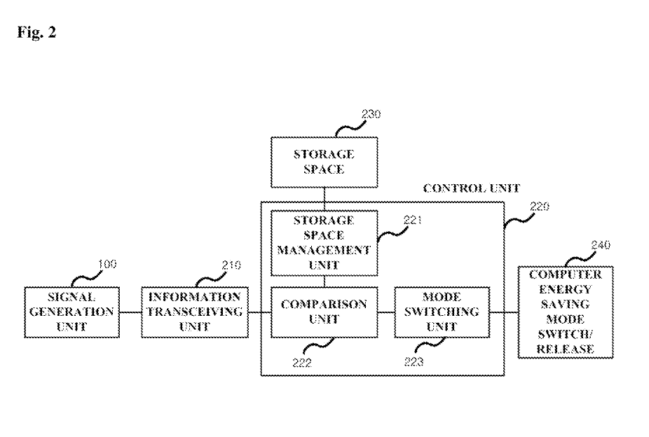

FIG. 2 is a diagram illustrating the first example of the energy-saving apparatus using the computer user information, according to the present invention.

Illustrated in an example of the energy-saving apparatus in which the information transceiving unit 210 is connected to the computer so that power consumption of the computer is controlled by using the computer user information received through the information transceiving unit 210.

As illustrated, the energy-saving apparatus includes the signal generation unit 100 which stores and transmits the computer user information, the information transceiving unit 210 which receives the computer user information from the signal generation unit 100, a control unit 220, and a storage space 230. By using these elements, the energy-saving apparatus performs a computer energy-saving mode switch/release function 240.

The energy-saving apparatus using the computer user information receives the computer user information through the information transceiving unit 210 from the signal generation unit 100 possessed by the computer user, and determines whether the computer user is located within the recognition range from the computer so as to control the energy-saving mode of the computer.

Herein, the signal generation unit 100 possessed by the user may be attached to the employee ID card or a pass of the user, or may be attached to a case thereof. Since the employee ID card or pass is always possessed, a company or public office may conveniently reduce the power consumption of computers without purchasing additional equipment. Also, the signal generation unit may be integrated with or connected to a personal item such as a cell phone or MP3 player.

The signal generation unit 100 continuously transmits the computer user information, and the information transceiving unit 210 receives the computer user information. Also, the information transceiving unit 210 not only receives the computer user information but also may transmit a computer user information request signal of the signal generation unit 100 according to the need. At least one piece of the computer user information may be stored into the signal generation unit 100, and may be amended or deleted according to the need. Also, the signal generation unit 100 may receive the computer user information stored in an IC chip or RFID tag which is an information storage unit of an IC card or RFID card through contact communication or RF communication, and may store the received information according to the need.

The information transceiving unit 210 may recognize the computer user information by wirelessly communicating with the signal generation unit 100 which is located within several meters or tens of meters from the information transceiving unit.

User authentication information for permitting use of the computer is stored in the storage space 230. By using the user authentication information, it is determined whether the computer user is authorized. When the use of the computer is limited to one person, authentication information on only one person may be stored. When the use of the computer is allowed to a plurality of users, authentication information on all the users may be stored. The user authentication information may be amended or deleted.

By comparing the user authentication information stored in the storage space 230 with the computer user information received through the information transceiving unit 210, it is determined whether to permit the use of the computer.

The control unit 220 compares the user authentication information stored in the storage space 230 with the computer user information received through the information transceiving unit 210, and determines whether the user authentication information is the same as the computer user information so as to determine whether to allow the computer to switch to the energy-saving mode. To this end, the control unit 220 may include a storage space management unit 221, a comparison unit 222, and a mode switching unit 223.

The storage space management unit 221 serves to store the user authentication information in the storage space 230 or delete the user authentication information. The user authentication information may be prestored in the storage space 230 by using a configuration program or the like, and may be amended or deleted according to the need.

When the computer user information is received from the information transceiving unit 210, the comparison unit 222 compares the computer user information with the user authentication information prestored in the storage space 230.

According to a result of the comparison performed by the comparison unit 222, when there is no user authentication information which is the same as the received computer user information or when the computer user information is not received, the mode switching unit 223 switching a state of the computer to the energy-saving mode to reduce the power consumption of the computer. When there is user authentication information which is the same as the computer user information, the energy-saving mode is finished.

In response to a signal of the mode switching unit 223, the computer switches to the energy-saving mode. More specifically, the mode switching unit 223 may switch the state of the computer to various modes for reducing the power consumption of the computer when the computer user is not recognized. For instance, the various modes may include a monitor turning off mode in which a monitor is turned off, a monitor power-saving mode for reducing power consumption of the monitor, a system standby mode in which a computer system is in a standby mode, a computer turning off mode in which the computer is turned off, a hard disk turning off mode in which a hard disk is turned off, and the like. The switching to the various modes may be preset by using the configuration program.

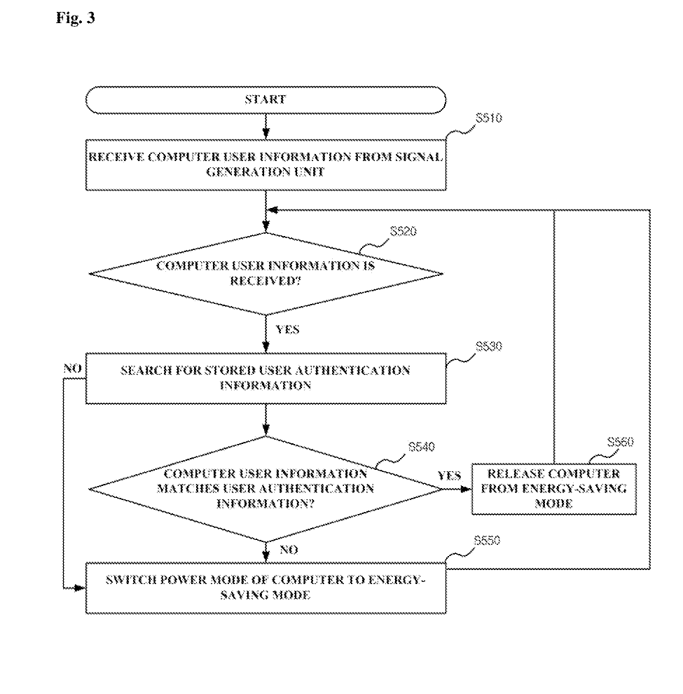

FIG. 3 is a diagram illustrating a first example of an energy-saving method using computer user information, according to the present invention.

According to the energy-saving method using the computer user information, firstly, the information transceiving unit 210 tries to receive the computer user information from the signal generation unit 100 in operation S510.

It is determined whether the computer user information is received in operation S520.

When it is determined that the computer user information is not received, the computer user is not considered to exist within the recognition range, and thus, the computer switches to the energy-saving mode in operation S550.

When it is determined that the computer user information is received, the user authentication information prestored in the storage space 230 is searched for in operation S530, and the received computer user information is compared to the user authentication information stored in the storage space 230 to determine whether the computer user information matches the user authentication information in operation S540.

When it is determined that the computer user information matches the user authentication information, the computer is released from the energy-saving mode in the case where the computer is in the energy-saving mode in operation S560.

When it is determined that the computer user information does not match the user authentication information, the computer user is not considered to be an authorized user, and thus, the computer switches to the energy-saving mode to save energy in operation S550. Thereafter, it is continuously determined whether the computer user information is received. Herein, the energy-saving mode may be maintained even when an input signal is received from an external device such as a keyboard or mouse. Also, the energy-saving mode may be automatically finished when the input signal is received from the external device such as the keyboard or mouse. This operation may be preset by the configuration program.

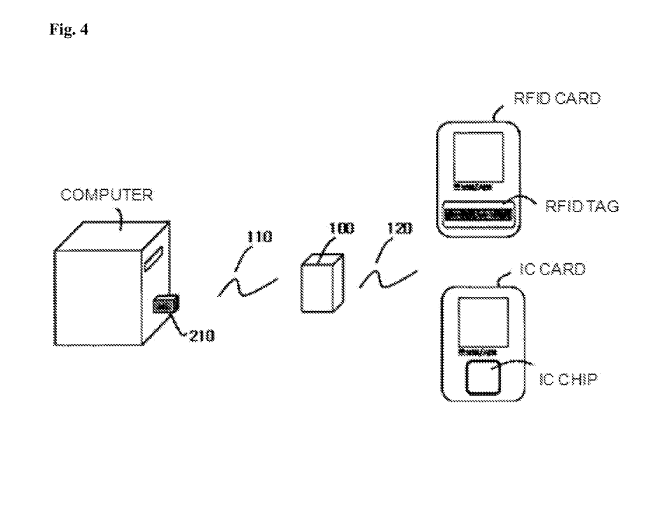

FIG. 4 is a diagram illustrating a second example of the energy-saving apparatus using the computer user information, according to the present invention.

The computer user information may be stored in the IC chip or RFID tag which is the information storage unit of the IC card or RFID card. The signal generation unit 100 receives the computer user information stored in the IC card or RFID card by performing RF communication 120 with the IC chip or RFID tag. Also, the signal generation unit may receive the computer user information by directly contacting the IC chip. The signal generation unit 100 transmits the received computer user information to the information transceiving unit 210 via wireless communication 110. By using the computer user information received through the information transceiving unit 210, the control unit 220 controls the energy-saving mode of the computer.

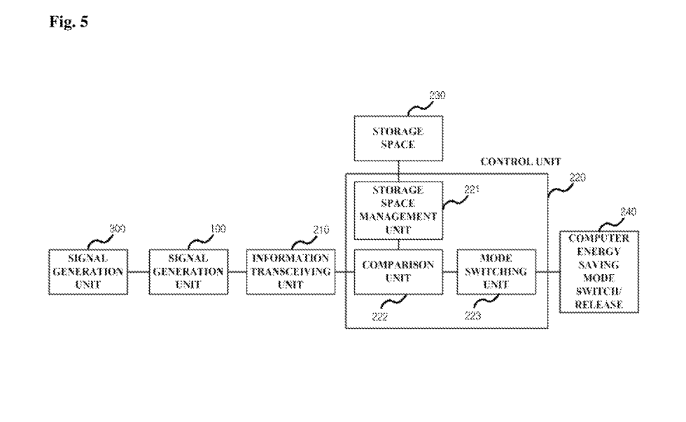

FIG. 5 is a diagram illustrating the second example of the energy-saving apparatus using the computer user information, according to the present invention.

The signal generation unit 100 receives the computer user information stored in an information storage unit 300 such as the IC chip or RFID tag. The control unit 220 compares the received computer user information with the user authentication information prestored in the storage space 230, and determines whether the user authentication information matches the computer user information so as to allow the computer to switch to the energy-saving mode.

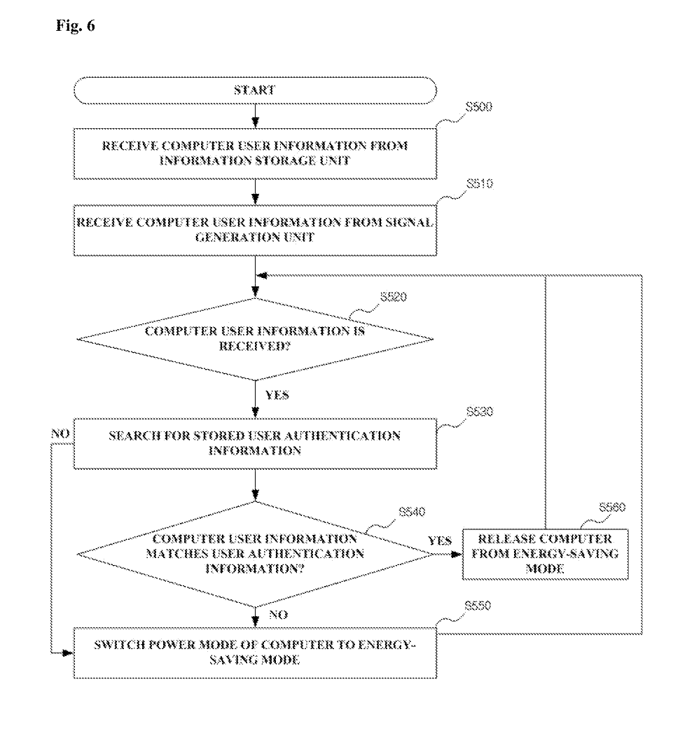

FIG. 6 is a diagram illustrating a second example of the energy-saving method using the computer user information, according to the present invention.

According to the energy-saving method using the computer user information, firstly, the signal generation unit 100 receives the computer user information stored in the information storage unit 300 such as the IC chip or RFID tag in operation S500.

The information transceiving unit 210 tries to receive the computer user information from the signal generation unit 100 in operation S510.

It is determined whether the computer user information is received in operation S520.

When it is determined that the computer user information is not received, the computer user is not considered to exist within the recognition range, and thus, the computer switches to the energy-saving mode in operation S550.

When it is determined that the computer user information is received, the user authentication information prestored in the storage space 230 is searched for in operation S530, and the received computer user information is compared to the user authentication information stored in the storage space 230 to determine whether the computer user information matches the user authentication information in operation S540.

When it is determined that the computer user information matches the user authentication information, the computer is released from the energy-saving mode in the case where the computer is in the energy-saving mode in operation S560.

When it is determined that the computer user information does not match the user authentication information, the computer user is not considered to be an authorized user, and thus, the computer switches to the energy-saving mode to save energy in operation S550. Thereafter, it is continuously determined whether the computer user information is received. Herein, the energy-saving mode may be maintained even when an input signal is received from an external device such as a keyboard or mouse. Also, the energy-saving mode may be automatically finished when the input signal is received from the external device such as the keyboard or mouse. This operation may be preset by the configuration program.

When the received computer user information matches the user authentication information stored in the storage space 230, the computer user may be considered to be an authorized user so that the energy-saving mode is finished. Further, when the received computer user information correlates with the user authentication information stored in the storage space 230, the computer user may also be considered to be an authorized user so that the energy-saving mode is finished. When the received computer user information does not correlate with the user authentication information, the computer user is not considered to be an authorized user so that the computer switches to the energy-saving mode. The matching between the computer user information and the user authentication information is included in the scope of the correlation. By using the correlation, the control unit 220 may perform the above-described energy-saving mode switching operation.

The present invention may be replaced, amended or modified by those skilled in the art, not being out of the spirit and scope of the inventive concept, and thus is not limited by the above-described embodiments and the accompanying drawings.

1. An energy-saving apparatus using computer user information, the apparatus comprising:
a signal generation unit configured to obtain computer user information stored in an own storage means or an additional information storage unit and transmit the computer user information through wireless communication;
an information transceiving unit configured to receive the computer user information transmitted from the signal generation unit;
a storage space configured to store user authentication information;
a comparison unit configured to compare the computer user information received from the information transceiving unit with the user authentication information stored in the storage space, and determine whether there is a correlation between the computer user information and the user authentication information; and
a mode switching unit configured to switch a power mode of the computer to an energy-saving mode according to a result of the determination of the comparison unit.

2. The apparatus of claim 1, wherein the additional information storage unit is an integrated circuit (IC) chip of an IC card or radio frequency identification (RFID) tag of RFID card.

3. The apparatus of claim 2, wherein the mode switching unit configures to finish or maintain the energy-saving mode in response to an input signal of a keyboard or mouse when the computer is in the energy-saving mode.

4. The apparatus of claim 2, the energy-saving mode comprises at least one of a monitor turning off mode, a monitor power-saving mode, a computer turning off mode, a system standby mode, and a hard disk turning off mode.

5. An energy-saving method using computer user information, the method comprising:
receiving computer user information from a signal generation unit by using an information transceiving unit;
determining whether there is a correlation between the received computer user information and user authentication information stored in a storage space by comparing the computer user information and the user authentication information; and
switching a computer power mode to an energy-saving mode according to a result of the comparing,
wherein the signal generation unit configures to obtain the computer user information stored in an own storage means or an additional information storage unit, and transmit the computer user information through wireless communication.

6. The method of claim 5, wherein the computer power mode is switched to the energy-saving mode when no information is received from the information transceiving unit.

7. (canceled)

8. (canceled)

9. (canceled)
